(19) United States
(12) Patent Application Publication
(10) Pub. No.: US 2019/0327714 A1
(43) Pub. Date: Oct. 24, 2019

(54) Dedicated User Equipment Beam Search for Fifth Generation New Radio

(71) Applicant: Google LLC, Mountain View, CA (US)

(72) Inventors: Jibing Wang, Saratoga, CA (US); Erik Richard Stauffer, Sunnyvale, CA (US)

(73) Assignee: Google LLC, Mountain View, CA (US)

(21) Appl. No.: 15/956,614

(22) Filed: Apr. 18, 2018

(51) Int. Cl. H04W 72/02; H04W 72/04; H04B 7/0404; H04B 7/0452; H04B 7/0417; H04B 7/06

(52) U.S. Cl. CPC H04W 72/02; H04W 72/046; H04B 7/0404; H04W 92/20; H04B 7/0417; H04B 7/0695; H04B 7/0639; H04B 7/0452

(57) ABSTRACT

In aspects of dedicated user equipment beam search for fifth generation new radio, a mobile communication device includes a first radio frequency transceiver, a second radio frequency transceiver, and a processor and memory system to implement a beamforming manager application that transmits a beam search request to a base station using the first radio frequency transceiver, receives a beam search notification from the base station, evaluates cell-specific reference signals included in beam search transmissions to select a beam to use for a 5G NR communication link and transmits an indication of the selected beam to the base station using the first radio transceiver, the transmission being effective to cause the base station to establish the 5G NR communication link with the mobile communication device using the selected beam.

### BACKGROUND

The evolution of wireless communication to fifth generation (5G) standards and technologies provides higher data rates and greater capacity, with improved reliability and lower latency, which enhances mobile broadband services. 5G technologies also provide new classes of services for vehicular, fixed wireless broadband, and the Internet of Things (IoT).

A unified air interface, which utilizes licensed, unlicensed, and shared license radio spectrum, in multiple frequency bands, is one aspect of enabling the capabilities of 5G systems. The 5G air interface utilizes radio spectrum in bands below 1 GHz (sub-gigahertz), below 6 GHz (sub-6 GHz), and above 6 GHz. Radio spectrum above 6 GHz includes millimeter wave (mmWave) frequency bands that provide wide channel bandwidths to support higher data rates for wireless broadband.

To increase the capacity of 5G radio networks, Multiple Input Multiple Output (MIMO) antenna systems are used to beamform signals transmitted between base stations and user terminals. In 5G networks, a large number of MIMO antennas (e.g., hundreds of antennas) are employed for beamforming signals, which is often referred to as Massive MIMO, to provide beamformed transmission and reception that is focused on small areas of space around individual user terminals. Massive MIMO beamforming improves network throughput, energy efficiency, and interference rejection. Massive MIMO systems use a channel estimate of the radio frequency (RF) channel characteristics between the base station and the user terminal to determine beamforming coefficients for transmission and reception.

The specification of the features in the 5G air interface for user equipment (UE) is defined as 5G New Radio (5G NR). Improvements in beamforming for 5G NR are particularly important at mmWave frequencies where it is challenging for the UE and a base station to track the beam between the UE and the base station. Synchronizing beamforming between the UE and the base station in 5G NR is based on broadcast synchronization using cell-specific reference signals that are transmitted periodically by base stations or a base station may periodically sweep across a set of beams so that the UE can track the base station. By being dependent on the periodic broadcasts from a base station, the UE is limited in how quickly the UE can react to changing channel conditions.

### SUMMARY

This summary is provided to introduce simplified concepts of dedicated user equipment beam search for fifth generation new radio. The simplified concepts are further described below in the Detailed Description. This summary is not intended to identify essential features of the claimed subject matter, nor is it intended for use in determining the scope of the claimed subject matter.

In some aspects, a mobile communication device includes a first radio frequency transceiver, a second radio frequency transceiver, and a processor and memory system to implement a beamforming manager application that transmits a beam search request to a base station using the first radio frequency transceiver and receives a beam search notification from the base station. The mobile communication device evaluates cell-specific reference signals included in beam search transmissions to select a beam to use for a 5G NR communication link and transmits an indication of the selected beam to the base station using the first radio transceiver, the transmission being effective to cause the base station to establish the 5G NR communication link with the mobile communication device using the selected beam.

In another aspect, a method for dedicated user equipment beam-searching for a fifth generation new radio (5G NR) communication link between a base station and a user equipment (UE) is described, in which a user equipment transmits a beam search request to the base station and receives a beam search notification from the base station. The UE evaluates cell-specific reference signals included in beam search transmissions to select a beam to use for the 5G NR communication link and transmits an indication of the selected beam that is effective to cause the base station to establish the 5G NR communication link with the UE using the selected beam.

In a further aspect, a system includes a gNode B (gNB) and a user equipment (UE) that is configured to transmit a beam search request to the gNB and receive a beam search notification from the gNB. The UE is further configured to evaluate cell-specific reference signals included in beam search transmissions to select a beam to use for a 5G NR communication link between the gNB and the UE and transmit an indication of the selected beam to the gNB that is effective to cause the gNB to establish the 5G NR communication link with the UE using the selected beam.

### BRIEF DESCRIPTION OF THE DRAWINGS

Aspects of dedicated user equipment beam search for fifth generation new radio are described with reference to the following drawings. The same numbers are used throughout the drawings to reference like features and components:

FIG. 1 illustrates an example wireless network system in which various aspects of dedicated user equipment beam search for fifth generation new radio can be implemented.

FIG. 2 illustrates an example device diagram that can implement various aspects of dedicated user equipment beam search for fifth generation new radio.

FIG. 3 illustrates an example environment in which various aspects of dedicated user equipment beam search for fifth generation new radio techniques can be implemented.

FIG. 4 illustrates an example of data and control transactions between devices in accordance with aspects of dedicated user equipment beam search for fifth generation new radio techniques.

FIG. 5 illustrates an example method of dedicated user equipment beam search for fifth generation new radio as generally related to requesting and performing a dedicated user equipment beam search by a user equipment and a base station in accordance with aspects of the techniques described herein.

FIG. 6 illustrates an example method of dedicated user equipment beam search for fifth generation new radio as generally related to evaluation of the received cell-specific reference signals in the beam search in accordance with aspects of the techniques described herein.

FIG. 7 illustrates an example method of dedicated user equipment beam search for fifth generation new radio as generally related to forwarding beam search communications between a user equipment and a base station in accordance with aspects of the techniques described herein.

FIG. 8 illustrates an example method of dedicated user equipment beam search for fifth generation new radio as generally related to scheduling and transmitting a dedicated beam search in accordance with aspects of the techniques described herein.

FIG. 9 illustrates an example communication device that can be implemented in a wireless network environment in accordance with one or more aspects of the techniques described herein.

### DETAILED DESCRIPTION

As wireless communication systems evolve to 5G NR technologies, 5G networks will be deployed in parallel with existing Long Term Evolution (LTE) networks. 5G NR networks increase capacity by adding new spectrum and utilizing beamforming techniques to optimize for the channel between the base station and the user equipment (UE). The base station transmits cell-specific reference signals (RS) distributed over various resource elements (RE) and/or timeslots of a 5G NR downlink. The cell-specific reference signals are evaluated by the user equipment to estimate channel conditions between the base station and the user equipment.

The base stations in the 5G NR network schedule when the cell-specific reference signals are transmitted. Scheduling transmission of the cell-specific reference signals by the base stations limits the ability of user equipment to track a beam and adjust to changing channel conditions between the periodic broadcasts of the cell-specific reference signals. Performing a beam search procedure can be used by the UE in a variety of circumstances, such as bootstrapping a 5G NR communication link via an LTE anchor link, as part of performing a handover to a neighbor cell, establishing an additional link with a neighbor base station for a carrier aggregation, and so forth.

In aspects, the user equipment initiates a dedicated user equipment beam search for a neighbor base station by sending a UE-specific beam search request to a base station, such as via an LTE anchor link with a serving cell base station. The serving cell base station forwards the UE-specific beam search request to the neighbor base station via an Xn interface that provides user-plane and control-plane data communication between the serving cell base station and the neighbor base station. The UE-specific beam search request includes parameters for the beam search procedure, such as the number of beams to transmit, the duration for the transmission of each beam during the beam search procedure, channels and/or frequency bands for the beam search procedure, and the like.

In further aspects, the neighbor base station responds to the UE-specific beam search request with a beam search notification that includes a time at which the neighbor base station will transmit the beams for the UE-specific beam search. The time at which the neighbor base station will transmit the beams may be indicated as a time, a slot, or in any other suitable manner. The response is sent via the Xn interface to the serving cell base station, which forwards the response to the user equipment. At the time included in the beam search notification, the neighbor base station transmits the beams for the UE-specific beam search and the user equipment evaluates each of the transmitted beams to select a beam for a 5G NR communication link between the user equipment and the neighbor base station.

In further aspects, the user equipment provides feedback to the neighbor base station for beamforming of the 5G NR link using closed-loop or beam-index beamforming for 5G NR. The neighbor base station and the user equipment both have a copy of a codebook that includes precoding matrices for beamforming with an index value (e.g., a precoding matrix indicator or PMI) associated with each precoding matrix in the codebook. The neighboring 5G NR base station transmits cell-specific reference signals (RS) distributed over various resource elements (RE) and/or timeslots of the 5G NR downlink. The cell-specific reference signals are evaluated by the user equipment to estimate channel conditions between the 5G NR neighbor base station and the user equipment. Based on the channel estimates, the user equipment selects a precoding matrix to use for beamforming and sends a response, which includes the PMI of the selected precoding matrix, via the serving cell base station. The neighbor base station uses the selected precoding matrix to beamform the 5G NR link to the user equipment.

While features and concepts of the described systems and methods for dedicated user equipment beam search for fifth generation new radio can be implemented in any number of different environments, systems, devices, and/or various configurations, aspects of dedicated user equipment beam search for fifth generation new radio are described in the context of the following example devices, systems, and configurations.

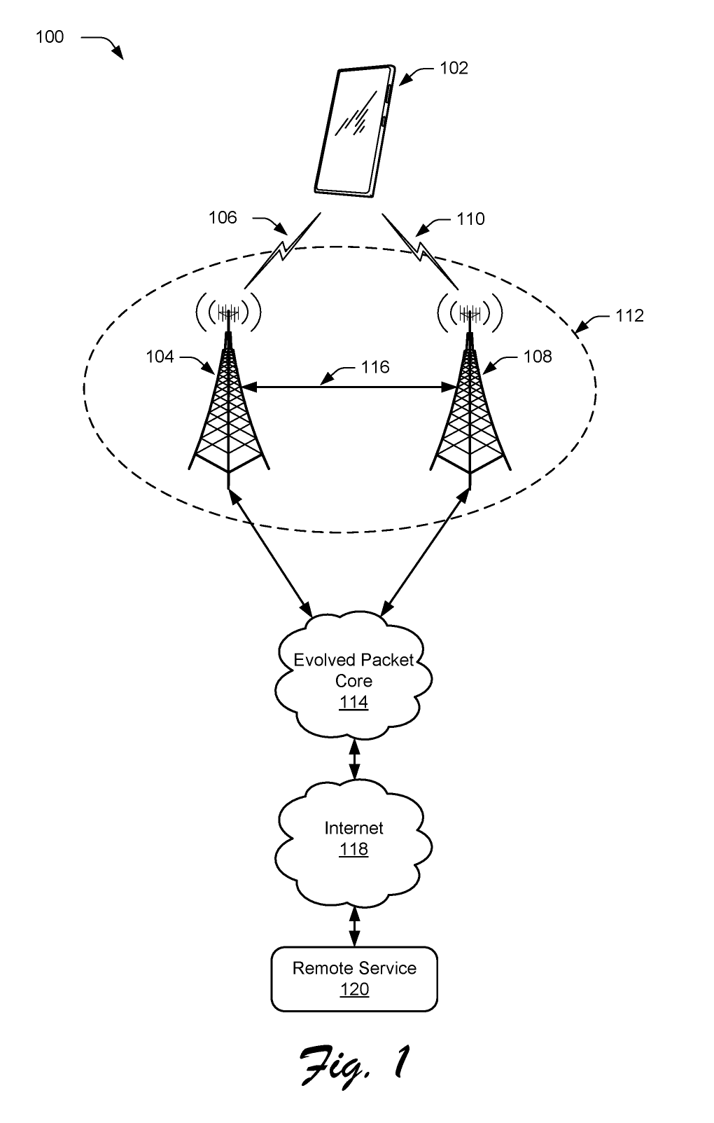

FIG. 1 illustrates an example environment 100 which includes a user equipment 102 that communicates with a base station 104 that acts as a serving cell, (serving cell base station 104), through a wireless communication link 106 (wireless link 106). In this example, the user equipment 102 is implemented as a smartphone. Although illustrated as a smartphone, the user equipment 102 may be implemented as any suitable computing or electronic device, such as a mobile communication device, a modem, cellular phone, gaming device, navigation device, media device, laptop computer, desktop computer, tablet computer, smart appliance, vehicle-based communication system, and the like. The base station 104 (e.g., an Evolved Universal Terrestrial Radio Access Network Node B, E-UTRAN Node B, evolved Node B, eNodeB, eNB, Next Generation Node B, gNode B, gNB, and the like) may be implemented in a macrocell, microcell, small cell, picocell, and the like, or any combination thereof.

The serving cell base station 104 communicates with the user equipment 102 via the wireless link 106, which may be implemented as any suitable type of wireless link. The wireless link 106 can include a downlink of data and control information communicated from the serving cell base station 104 to the user equipment 102 and/or an uplink of other data and control information communicated from the user equipment 102 to the serving cell base station 104. The wireless link 106 may include one or more wireless links or bearers implemented using any suitable communication protocol or standard, or combination of communication protocols or standards such as 3rd Generation Partnership Project Long-Term Evolution (3GPP LTE), 5G NR, and so forth.

In aspects, the user equipment 102 communicates with another base station 104 (a neighbor base station 108), via a wireless link 110. The wireless link 110 may be implemented using the same communication protocol or standard, or a different communication protocol or standard, then the wireless link 106. For example, the wireless link 106 is an LTE link and the wireless link 110 is a 5G NR link. The serving cell base station 104, the neighbor base station 108, and any additional base stations (not illustrated for clarity) are collectively a Radio Access Network 112 (RAN 112, Evolved Universal Terrestrial Radio Access Network 112, E-UTRAN 112), which are connected via an Evolved Packet Core 114 (EPC 114) network to form a wireless operator network. The serving cell base station 104 and the neighbor base station 108 can communicate using an Xn Application Protocol (XnAP), at 116, to exchange user-place and control-plane data. The UE 102 may connect, via the EPC 114, to public networks, such as the Internet 118 to interact with a remote service 120.

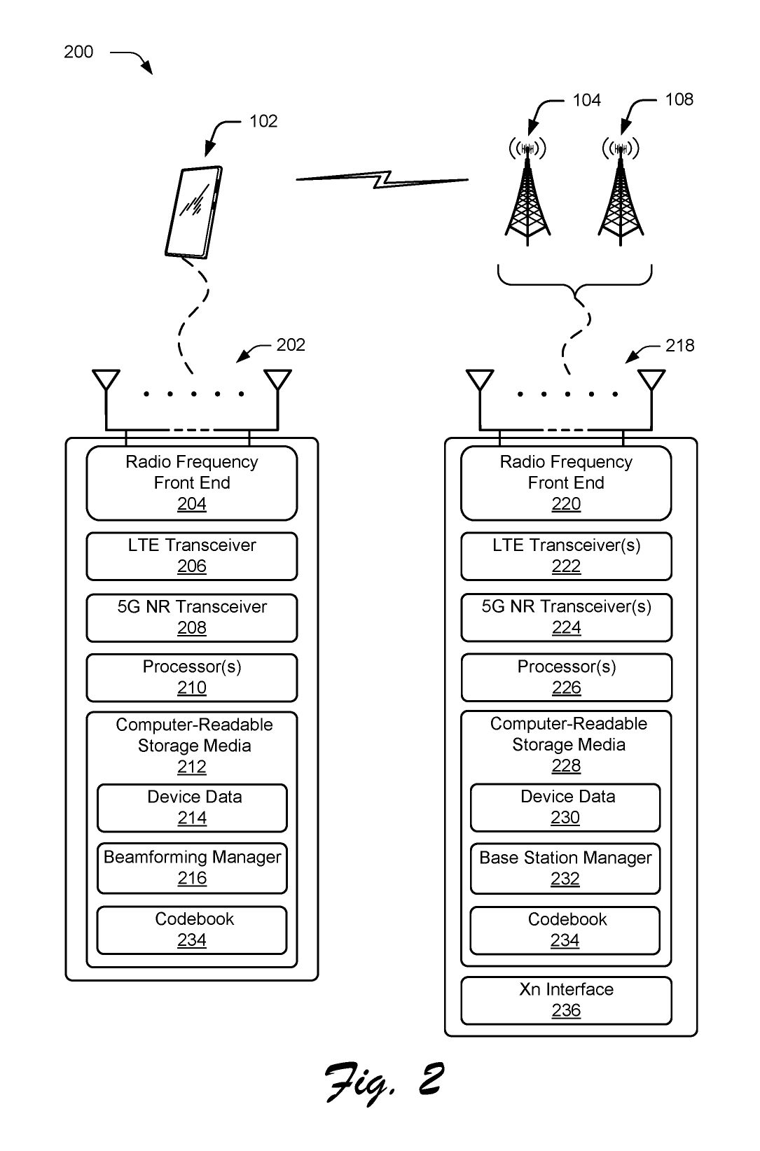

FIG. 2 illustrates an example device diagram 200 of the user equipment 102, the serving cell base station 104, and the neighbor base station 108. It should be noted that only the essential features of the user equipment 102, the serving cell base station 104, and the neighbor base station 108 are illustrated here for the sake of clarity. The user equipment 102 includes antennas 202, a radio frequency front end 204 (RF front end 204), an LTE transceiver 206, and a 5G NR transceiver 208 for communicating with base stations 104 in the E-UTRAN 112. The RF front end 204 of the user equipment 102 can couple or connect the LTE transceiver 206, and the 5G NR transceiver 208 to the antennas 202 to facilitate various types of wireless communication. The antennas 202 of the user equipment 102 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. By way of example and not limitation, the antennas 202 and the RF front end 204 can be implemented for operation in sub-gigahertz bands, sub-6 GHZ bands, and/or above 6 GHz bands that are defined by the 3GPP LTE and 5G NR communication standards. Alternatively, the 5G NR transceiver 208 may be replaced with a 5G NR receiver and operations describe herein as performed by the 5G NR transceiver 208 may performed by the 5G NR receiver.

The user equipment 102 also includes processor(s) 210 and computer-readable storage media 212 (CRM 212). The processor 210 may be a single core processor or a multiple core processor composed of a variety of materials, such as silicon, polysilicon, high-K dielectric, copper, and so on. The computer-readable storage media described herein excludes propagating signals. CRM 212 may include any suitable memory or storage device such as random-access memory (RAM), static RAM (SRAM), dynamic RAM (DRAM), non-volatile RAM (NVRAM), read-only memory (ROM), or Flash memory useful to store device data 214 of the user equipment 102. The device data 214 includes user data, multimedia data, applications, and/or an operating system of the user equipment 102, which are executable by processor(s) 210 to enable user interaction with the user equipment 102.

CRM 212 also includes a beamforming manager 216, which, in one implementation, is embodied on CRM 212 (as shown). Alternately or additionally, the beamforming manager 216 may be implemented in whole or part as hardware logic or circuitry integrated with or separate from other components of the user equipment 102. In at least some aspects, the beamforming manager 216 configures the RF front end 204, the LTE transceiver 206, and/or the 5G NR transceiver 208 to implement the techniques for dedicated user equipment beam search for fifth generation new radio described herein.

The device diagram for the serving cell base station 104 and the neighbor base station 108 shown in FIG. 2 includes a single network node (e.g. an E-UTRAN Node B or gNode B). The functionality of the serving cell base station 104 and/or the neighbor base station 108 may be distributed across multiple network nodes and/or devices, may be and distributed in any fashion suitable to perform the functions described herein. The serving cell base station 104 and the neighbor base station 108 include antennas 218, a radio frequency front end 220 (RF front end 220), one or more LTE transceivers 222, and/or one or more 5G NR transceivers 224 for communicating with the user equipment 102. The RF front end 220 of the serving cell base station 104 and the neighbor base station 108 can couple or connect the LTE transceivers 222 and the 5G NR transceivers 224 to the antennas 218 to facilitate various types of wireless communication. The antennas 218 of the serving cell base station 104 and the neighbor base station 108 may include an array of multiple antennas that are configured similar to or differently from each other. The antennas 218 and the RF front end 220 can be tuned to, and/or be tunable to, one or more frequency band defined by the 3GPP LTE and 5G NR communication standards, and implemented by the LTE transceivers 222, and/or the 5G NR transceivers 224. Additionally, the antennas 218, the RF front end 220, the LTE transceivers 222, and/or the 5G NR transceivers 224 may be configured to support beamforming, such as Massive-MIMO, for the transmission and reception of communications with the user equipment 102.

The serving cell base station 104 and the neighbor base station 108 also include processor(s) 226 and computer-readable storage media 228 (CRM 228). The processor 226 may be a single core processor or a multiple core processor composed of a variety of materials, such as silicon, polysilicon, high-K dielectric, copper, and so on. CRM 228 may include any suitable memory or storage device such as random-access memory (RAM), static RAM (SRAM), dynamic RAM (DRAM), non-volatile RAM (NVRAM), read-only memory (ROM), or Flash memory useful to store device data 230 of the serving cell base station 104 and the neighbor base station 108. The device data 230 includes network scheduling data, radio resource management data, applications, and/or an operating system of the serving cell base station 104 and the neighbor base station 108, which are executable by processor(s) 226 to enable communication with the user equipment 102.

CRM 228 also includes a base station manager 232, which, in one implementation, is embodied on CRM 228 (as shown). Alternately or additionally, the base station manager 232 may be implemented in whole or part as hardware logic or circuitry integrated with or separate from other components of the serving cell base station 104 and the neighbor base station 108. In at least some aspects, the base station manager 232 configures the LTE transceivers 222 and the 5G NR transceivers 224 for communication with the user equipment 102, as well as communication with the EPC 114. The serving cell base station 104 and the neighbor base station 108 include an Xn interface 236, which the base station manager 232 configures to exchange user-plane and control-plane data between the serving cell base station 104 and the neighbor base station 108, to manage the communication of the serving cell base station 104 and/or the neighbor base station 108 with the user equipment 102.

### Closed-Loop Beamforming Feedback

In aspects, the user equipment 102 provides feedback to the neighbor base station 108 for beamforming of the 5G NR downlink via the serving cell base station 104. For example, beamforming for Massive MIMO uses closed-loop or beam-index beamforming for the 5G NR downlink. The neighbor base station 108 and the user equipment 102 both have a copy of a codebook 234 that includes precoding matrices for beamforming with an index value (e.g., a precoding matrix indicator or PMI) associated with each precoding matrix. The codebook 234 can be stored in the CRM 212 of the user equipment 102 and in the CRM 228 of the neighbor base station 108.

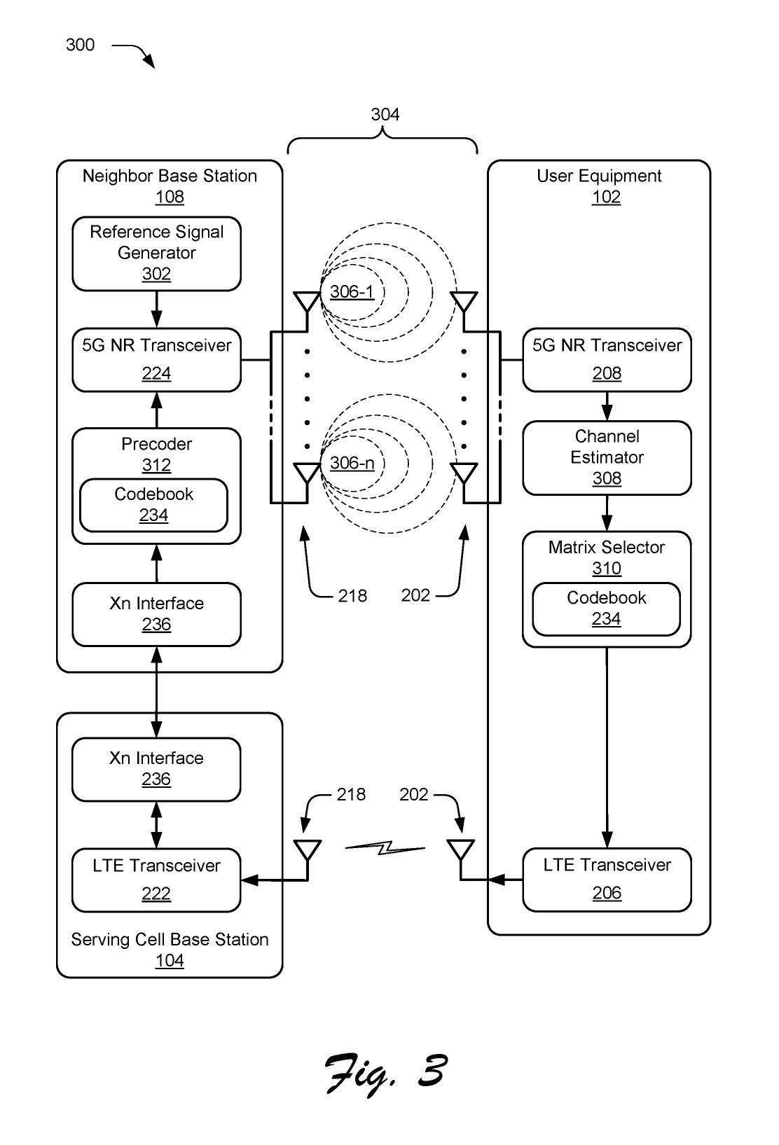

FIG. 3 illustrates an example environment 300 in which various aspects of dedicated user equipment beam search for fifth generation new radio techniques can be implemented. The environment 300 illustrates the user equipment 102 providing feedback for beamforming the 5G NR downlink to the neighbor base station 108, via the serving cell base station 104.

In aspects, to determine the precoding matrix for beamforming the 5G NR downlink, the neighbor base station 108 transmits cell-specific reference signals (RS) distributed over various resource elements (RE) and/or timeslots of the 5G NR downlink. The user equipment 102 evaluates the received cell-specific reference signals to estimate channel conditions between the neighbor base station 108 and the user equipment 102. Based on the channel estimate for each of the received cell-specific reference signals, the user equipment 102 selects a precoding matrix for beamforming the 5G NR downlink transmissions. The user equipment 102 sends a response that includes the PMI of the selected precoding matrix, via the serving cell base station 104. The serving cell base station 104 sends the PMI of the selected precoding matrix to the neighbor base station 108 using the Xn interface 236. The neighbor base station 108 uses the selected precoding matrix to beamform the 5G NR downlink to the user equipment. The process of determining the precoding matrix can be repeated periodically based on changes in channel quality, location changes of the user equipment 102, on-demand by the user equipment 102, and so forth.

For example, a reference signal generator 302 generates cell-specific reference signals that are provided to the 5G NR transceiver 224 for transmission over an RF channel 304, using the antennas 218. 5G NR downlink signals 306 that are modulated with the cell-specific reference signals are radiated from the antennas 218 (illustrated as 306-1 through 306-n) via the RF channel 304 and are received at the antennas 202 of the user equipment 102. The 5G NR transceiver 208 demodulates the received 5G NR downlink signals 306 and provides the demodulated cell-specific reference signals to a channel estimator 308, which generates an estimate of the quality of the RF channel 304 from the received cell-specific reference signals.

Based on the channel estimate for each of the received cell-specific reference signals, a matrix selector 310 determines the best precoding matrix to use for beamforming the 5G NR downlink from the neighbor base station 108 to the user equipment 102. The matrix selector 310 includes, or has access to, the codebook 234 and uses the codebook 234 to determine the precoding matrix indicator (PMI) for the best precoding matrix to use for beamforming the 5G NR downlink. The matrix selector 310 provides the PMI to the LTE transceiver 206. The LTE transceiver 206 transmits the PMI to the serving cell base station 104 in a message on a control channel, such as a Physical Uplink Control Channel (PUCCH), a Physical Uplink Shared Channel (PUSCH), or the like. The PMI is received by the LTE transceiver 222 in the serving cell base station 104 and communicated, via the Xn interface 236 in the serving cell base station 104, to the neighbor base station 108. The neighbor base station 108 receives the PMI via the Xn interface 236 and provides the PMI to a precoder 312, which uses the PMI as an index into the codebook 234 to lookup the precoding matrix for beamforming. The precoder 312 uses the precoding matrix from the lookup in the codebook 234 to beamform transmissions of 5G NR downlink by the 5G NR transceiver 224.

User Equipment Initiated, Dedicated Beam Search

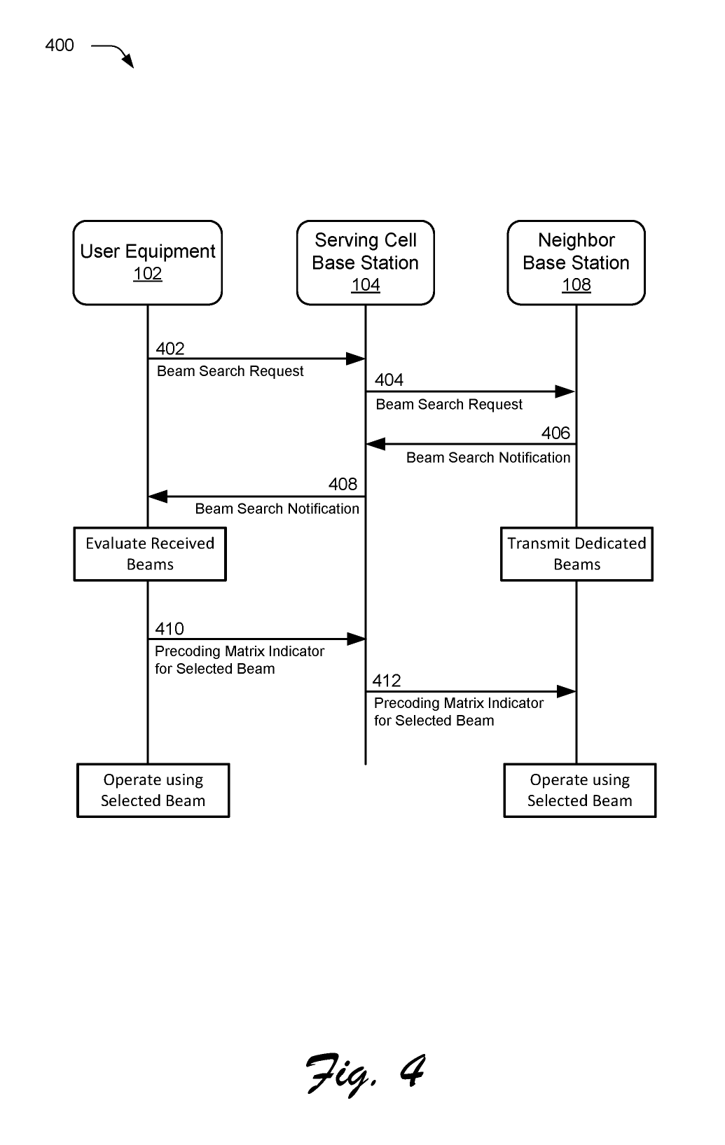

FIG. 4 illustrates an example of data and control transactions 400 between devices in accordance with aspects of dedicated user equipment beam search for fifth generation new radio. The user equipment 102 initiates a dedicated user equipment beam search procedure with the neighbor base station 108 by sending a beam search request to the serving cell base station 104, at 402. For example, the beam search request is transmitted in a Radio Resource Control (RRC) connection, a Media Access Control (MAC) layer Information Element (IE), or in any other suitable manner. The serving cell base station 104 forwards the beam search request to the neighbor base station 108, via the Xn interface 236, at 404.

In response to receiving the beam search request, the neighbor base station 108 schedules a time at which it can transmit cell-specific reference signals for the dedicated beam search. The neighbor base station 108 sends a beam search notification to the serving cell base station 104, via the Xn interface 236, at 406. The beam search notification includes the time at which the cell-specific reference signals for the dedicated beam search will be transmitted. At 408, the serving cell base station 104 forwards the bean search notification to the user equipment 102. At the time determined by the neighbor base station 108, the neighbor base station 108 transmits the cell-specific reference signals for the dedicated beam search and the user equipment 102 receives and evaluates the cell-specific reference signals in the received beams.

After evaluating the cell-specific reference signals in the received beams, the user equipment selects the best precoding matrix for beamforming and sends the PMI for that precoding matrix to the serving sell base station 104, at 410. At 412, the serving cell base station 104 then sends the PMI for the selected precoding matrix to the neighbor base station 108, via the Xn interface 236.

Alternatively or additionally, in another aspect, the neighbor base station 108 provides a supplemental uplink, such as an LTE link, that operates at a lower RF frequency, such as a sub-gigahertz frequency. The supplemental uplink has a larger coverage area than the higher frequency 5G NR signals and has less need for beamforming. The user equipment 102 communicates the beam search request to the neighbor base station 108 using the supplemental uplink, without the need to send the beam search request via the serving cell base station 104.

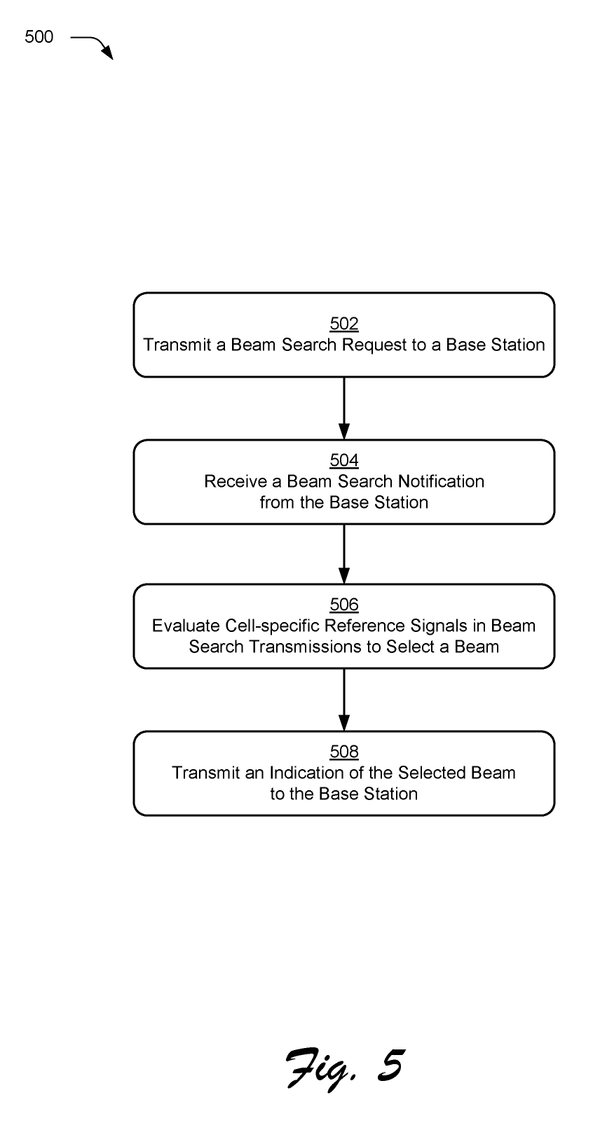

Example methods 500-800 is described with reference to FIGS. 5-8 in accordance with one or more aspects of dedicated user equipment beam search for fifth generation new radio. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 5 illustrates example method(s) 500 of dedicated user equipment beam search for fifth generation new radio as generally related to requesting and performing a dedicated user equipment beam search by the user equipment 102 and the neighbor base station 108. The order in which the method blocks are described are not intended to be construed as a limitation, and any number of the described method blocks can be combined in any order to implement a method, or an alternate method.

At block 502, a user equipment transmits a beam search request to a base station, the beam search request including parameters for a beam search. For example, the user equipment 102 transmits a beam search request to the neighbor base station 108 via the serving cell base station 104. Alternatively, the user equipment 102 transmits the beam search request to the neighbor base station 108 via a supplemental uplink of the neighbor base station 108.

At block 504, the user equipment receives a beam search notification from the base station, the beam search notification indicating a time at which cell-specific reference signals for the beam search will be transmitted by the base station. For example, the user equipment 102 receives a beam search notification from the neighbor base station 108.

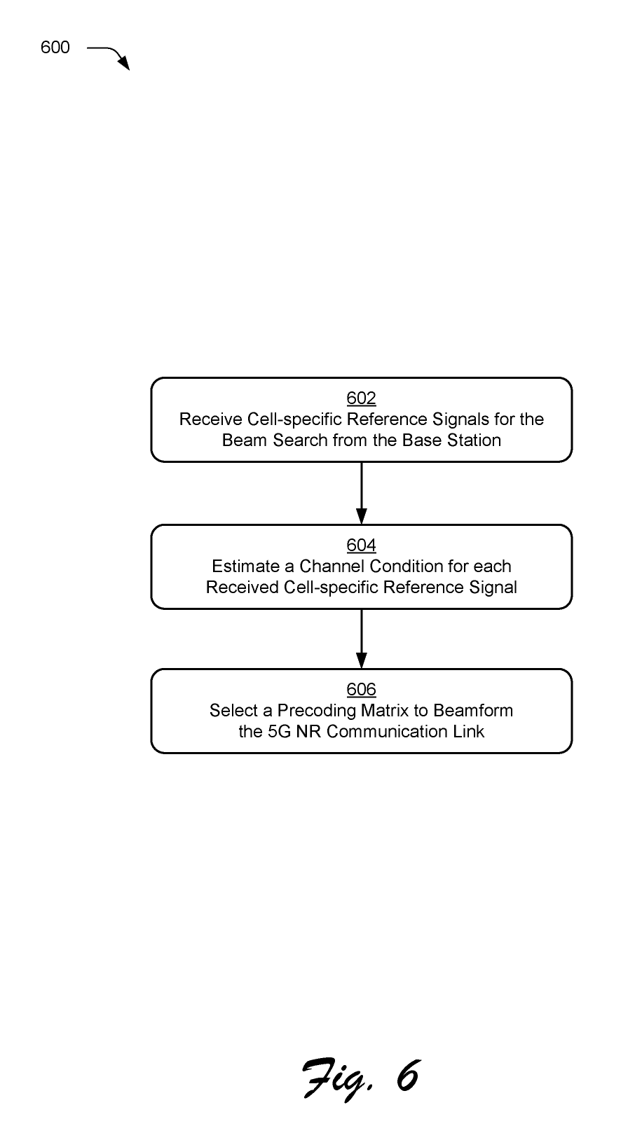

At block 506, the user equipment evaluates the cell-specific reference signals included in beam search transmissions to select a beam to use for a 5G NR communication link between the base station and the user equipment. For example, the user equipment 102 evaluates the cell-specific reference signals included in beam search transmissions, as further described below with reference to FIG. 6, to select a beam to use for a 5G NR communication link between the neighbor base station 108 and the user equipment 102.

At block 508, the user equipment transmits an indication of the selected beam to the base station, the transmission being effective to cause the base station to establish the 5G NR communication link with the user equipment using the selected beam. For example, the user equipment 102 transmits an indication of the selected beam to the neighbor base station 108 via the serving cell base station 104, the transmission being effective to cause the neighbor base station 108 to establish the 5G NR communication link with the user equipment using the selected beam. Alternatively, the user equipment 102 transmits the indication of the selected beam to the neighbor base station 108 via a supplemental uplink of the neighbor base station 108.

FIG. 6 illustrates example method(s) 600 of dedicated user equipment beam search for fifth generation new radio as generally related to evaluation of the received cell-specific reference signals in the beam search. The order in which the method blocks are described are not intended to be construed as a limitation, and any number of the described method blocks can be combined in any order to implement a method, or an alternate method.

At block 602, the user equipment receives cell-specific reference signals for the beam search from the base station. For example, the user equipment 102 receives cell-specific reference signals distributed over various resource elements and/or timeslots of a 5G NR downlink that are transmitted by the neighbor base station 108, based on the parameters included in the beam search request.

At block 604, the user equipment estimates a channel condition for each of the received cell-specific reference signals. For example, the channel estimator 308 in the user equipment 102 estimates a channel condition for each of the cell-specific reference signals received from the neighbor base station 108.

At block 606, based on the estimates of the channel conditions, the user equipment selects a precoding matrix for beamforming the 5G NR communication link with the base station. For example, the matrix selector 310 in the user equipment 102 evaluates the estimates of the channel conditions and selects a precoding matrix, from a codebook 234 shared with the neighbor base station 108, to beamform the 5G NR communication link.

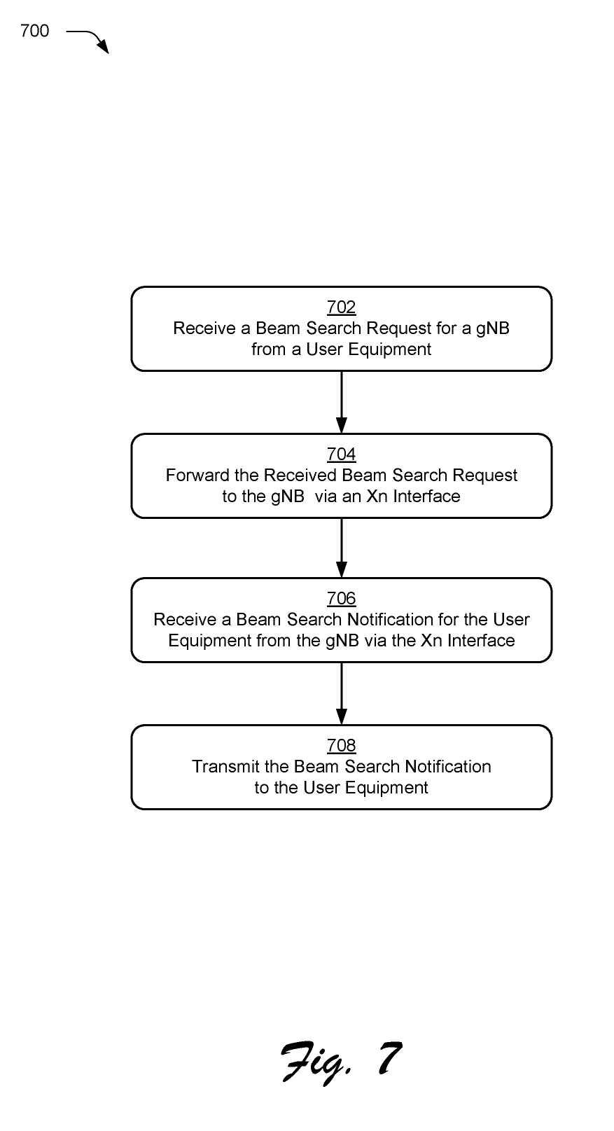

FIG. 7 illustrates example method(s) 700 of dedicated user equipment beam search for fifth generation new radio as generally related to forwarding beam search communications between a user equipment and a base station. The order in which the method blocks are described are not intended to be construed as a limitation, and any number of the described method blocks can be combined in any order to implement a method, or an alternate method.

At block 702, a serving cell gNB receives a beam search request for a gNB from a user equipment. For example, the serving cell base station 104 receives a beam search request for the neighbor base station 108 from the user equipment 102.

At block 704, the serving cell gNB forwards the received beam search request to the gNB, via an Xn interface. For example, the serving cell base station 104 forwards the received beam search request to the neighbor base station 108 via the Xn interface 236.

At block 706, the serving cell gNB receives a beam search notification for the user equipment from the gNB, via the Xn interface. For example, the serving cell base station 104 receives a beam search notification for the user equipment 102 from the neighbor base station 108, via the Xn interface 236.

At block 708, the serving cell gNB transmits the beam search notification to the user equipment. For example, the serving cell base station 104 transmits the beam search notification to the user equipment 102.

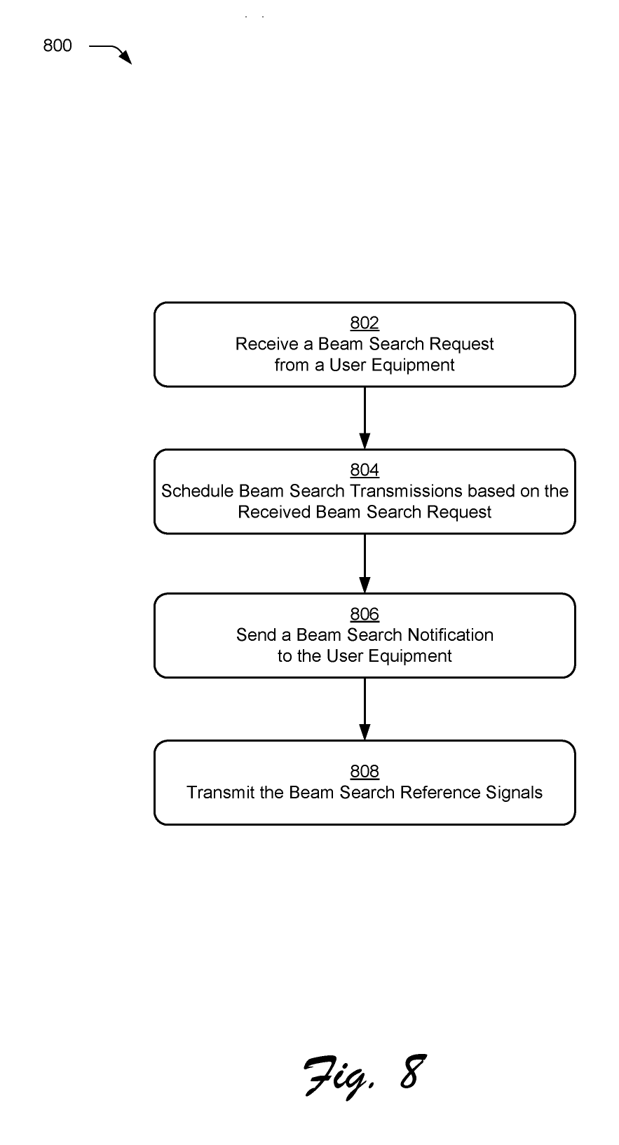

FIG. 8 illustrates example method(s) 800 of dedicated user equipment beam search for fifth generation new radio as generally related to scheduling and transmitting a dedicated beam search. The order in which the method blocks are described are not intended to be construed as a limitation, and any number of the described method blocks can be combined in any order to implement a method, or an alternate method.

At block 802, a gNB receives a beam search request from a user equipment. For example, the neighbor base station 108 receives a beam search request from the user equipment 102 via the Xn interface 236, the beam search request having been forwarded by the serving cell base station 104. Alternatively, the neighbor base station 108 receives the beam search request from the user equipment 102 via a supplemental uplink of the neighbor base station 108.

At block 804, the gNB schedules beam search transmissions based on the parameters included in the received beam search request. For example, the neighbor base station 108 evaluates the received beam search request and schedules beam search transmissions.

At block 806, the gNB sends a beam search notification to the user equipment. For example, the neighbor base station 108 sends a beam search notification to the user equipment 102 that includes an indication of the time at which the neighbor base station 108 has scheduled the beam search transmissions.

At block 808, the gNB transmits the cell-specific reference signals for the beam search. For example, the neighbor base station 108 transmits cell-specific reference signals for the beam search at the scheduled time.

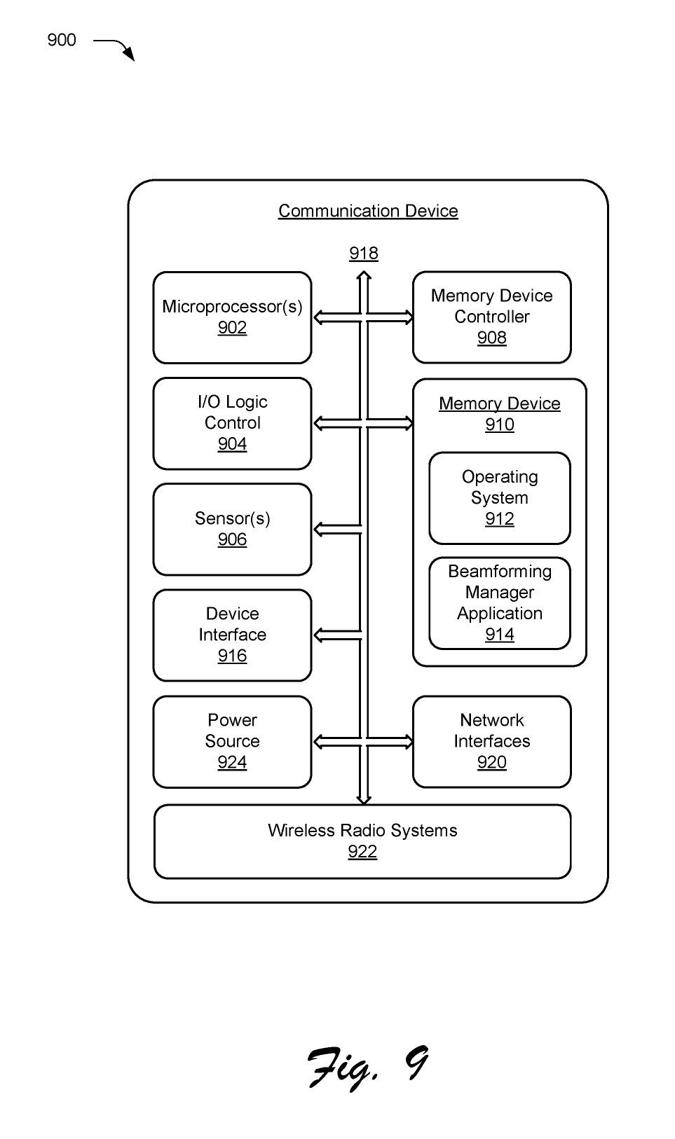

FIG. 9 illustrates an example communication device 900 that can be implemented as the user equipment 102 in accordance with one or more aspects of dedicated user equipment beam search for fifth generation new radio as described herein. The example communication device 900 may be any type of mobile communication device, computing device, client device, mobile phone, tablet, communication, entertainment, gaming, media playback, and/or other type of device.

The communication device 900 can be integrated with electronic circuitry, microprocessors, memory, input output (I/O) logic control, communication interfaces and components, as well as other hardware, firmware, and/or software to implement the device. Further, the communication device 900 can be implemented with various components, such as with any number and combination of different components as further described with reference to the user equipment 102 shown in FIGS. 1-3.

In this example, the communication device 900 includes one or more microprocessors 902 (e.g., microcontrollers or digital signal processors) that process executable instructions. The device also includes an input-output (I/O) logic control 904 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits.

The one or more sensors 906 can be implemented to detect various properties such as acceleration, temperature, humidity, supplied power, proximity, external motion, device motion, sound signals, ultrasound signals, light signals, global-positioning-satellite (GPS) signals, radio frequency (RF), other electromagnetic signals or fields, or the like. As such, the sensors 906 may include any one or a combination of temperature sensors, humidity sensors, accelerometers, microphones, optical sensors up to and including cameras (e.g., charged coupled-device or video cameras), active or passive radiation sensors, GPS receivers, and radio frequency identification detectors.

The communication device 900 includes a memory device controller 908 and a memory device 910 (e.g., the computer-readable storage media 212), such as any type of a nonvolatile memory and/or other suitable electronic data storage device. The communication device 900 can also include various firmware and/or software, such as an operating system 912 that is maintained as computer executable instructions by the memory and executed by a microprocessor. The device software may also include a beamforming manager application 914 that implements aspects of dedicated user equipment beam search for fifth generation new radio. The computer-readable storage media described herein excludes propagating signals.

The communication device 900 also includes a device interface 916 to interface with another device or peripheral component, and includes an integrated data bus 918 that couples the various components of the communication device 900 for data communication between the components. The data bus in the mesh network device may also be implemented as any one or a combination of different bus structures and/or bus architectures.

The device interface 916 may receive input from a user and/or provide information to the user (e.g., as a user interface), and a received input can be used to determine a setting. The device interface 916 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 916 may also receive inputs from any number of peripherals, such as buttons, a keypad, a switch, a microphone, and an imager (e.g., a camera device).

The communication device 900 can include network interfaces 920, such as a wired and/or wireless interface for communication with other devices via Wireless Local Area Networks (WLANs), wireless Personal Area Networks (PANs), and for network communication, such as via the Internet. The network interfaces 920 may include Wi-Fi, Bluetooth™, BLE, and/or IEEE 802.15.4. The communication device 900 also includes wireless radio systems 922 for wireless communication with cellular and/or mobile broadband networks. Each of the different radio systems can include a radio device, antenna, and chipset that is implemented for a particular wireless communications technology, such as the antennas 202, the RF front end 204, the LTE transceiver 206, and/or the 5G NR transceiver 208. The communication device 900 also includes a power source 924, such as a battery and/or to connect the device to line voltage. An AC power source may also be used to charge the battery of the device.

Although aspects of dedicated user equipment beam search for fifth generation new radio have been described in language specific to features and/or methods, the subject of the appended claims is not necessarily limited to the specific features or methods described. Rather, the specific features and methods are disclosed as example implementations of dedicated user equipment beam search for fifth generation new radio, and other equivalent features and methods are intended to be within the scope of the appended claims. Further, various different aspects are described, and it is to be appreciated that each described aspect can be implemented independently or in connection with one or more other described aspects.

What is claimed is:

1. A mobile communication device comprising:
a first radio frequency transceiver;
a second radio frequency transceiver; and
a processor and memory system to implement a beamforming manager application configured to:
transmit a beam search request to a base station using the first radio frequency transceiver, the beam search request including parameters for a beam search;
receive from the base station a beam search notification, the beam search notification including a time at which cell-specific reference signals for the beam search will be transmitted by the base station;
evaluate the cell-specific reference signals included in beam search transmissions to select a beam to use for a 5G NR communication link; and
transmit, using the first radio transceiver, an indication of the selected beam to the base station, the transmission being effective to cause the base station to establish the 5G NR communication link with the mobile communication device using the selected beam.

2. The mobile communication device of claim 1, wherein to evaluate the cell-specific reference signals included in the beam search, the beamforming manager application is configured to:
receive the cell-specific reference signals from the base station with the second radio frequency transceiver;
estimate a channel condition for each of the received cell-specific reference signals; and
based on the estimation of the channel conditions, select a precoding matrix to use for beamforming the 5G NR communication link.

3. The mobile communication device of claim 2, wherein the precoding matrix is selected from a codebook, wherein the codebook is shared between the mobile communication device and the base station, and wherein the indication of the selected precoding matrix is an index into the codebook usable to access the selected precoding matrix.

4. The mobile communication device of claim 2, wherein the indication of the selected precoding matrix is a Precoding Matrix Indicator (PMI), and wherein the PMI is transmitted from the mobile communication device to the base station via a Physical Uplink Control Channel (PUCCH) or a Physical Uplink Shared Channel (PUSCH).

5. The mobile communication device of claim 1, wherein the beam search request is transmitted in a Radio Resource Control (RRC) connection, or a Media Access Control (MAC) layer Information Element (IE).

6. The mobile communication device of claim 1, wherein the base station is a neighbor base station.

7. The mobile communication device of claim 6, wherein the transmission of the beam search request by the mobile communication device comprises transmission of the beam search request to a serving cell base station, the transmission of the beam search request to the serving cell base station being effective to cause the serving cell base station to forward the beam search request to the neighbor base station.

8. The mobile communication device of claim 7, wherein the serving cell base station and the neighbor base station include an Xn interface, and wherein the serving cell base station forwards the beam search request to the neighbor base station via the Xn interface.

9. The mobile communication device of claim 8, wherein the beam search notification and the indication of the beam to use for the 5G NR communication link are forwarded via the serving cell base station using the Xn interface.

10. The mobile communication device of claim 1, wherein the parameters for the beam search include one or more of: a number of beams to transmit during the beam search, a duration of transmission for each beam during the beam search, and a channel or frequency band for the beam search.

11. The mobile communication device of claim 1, wherein the beam search request, and the indication of the beam to use for the 5G NR communication link are communicated using via a supplemental uplink of the base station.

12. The mobile communication device of claim 1, wherein the first radio frequency transceiver is a Long Term Evolution (LTE) transceiver, and wherein the second radio frequency transceiver is a 5G NR transceiver.

13. A method for dedicated user equipment beam-searching for a fifth-generation new radio (5G NR) communication link between a base station and a user equipment (UE), the method comprising:
transmitting, by the UE, a beam search request to the base station, the beam search request including parameters for a beam search;
receiving, from the base station, a beam search notification, the beam search notification including a time at which cell-specific reference signals for the beam search will be transmitted by the base station;
evaluating, by the UE, the cell-specific reference signals included in beam search transmissions to select a beam to use for the 5G NR communication link; and
transmitting, by the UE, an indication of the selected beam, the transmitting the indication of the selected beam being effective to cause the base station to establish the 5G NR communication link with the UE using the selected beam.

14. The method of claim 13, the evaluating the cell-specific reference signals included in the beam search comprising:
receiving the cell-specific reference signals from the base station;
estimating a channel condition for each of the received cell-specific reference signals; and
based on the estimating of the channel conditions, selecting a precoding matrix to use for beamforming the 5G NR communication link with the base station.

15. The method of claim 13, wherein the transmitting the beam search request by the UE comprises transmitting the beam search request to a serving cell base station, the transmitting the beam search request to the serving cell base station being effective to cause the serving cell base station to forward the beam search request via an Xn interface to the base station.

16. The method of claim 13, wherein the parameters for the beam search include one or more of: a number of beams to transmit during the beam search, a duration of transmission for each beam during the beam search, and a channel or frequency band for the beam search.

17. A system comprising:
a gNode B (gNB) including an Xn interface; and
a user equipment (UE) configured to:
transmit a beam search request to the gNB, the beam search request including parameters for a beam search;
receive, from the gNB, a beam search notification, the beam search notification including a time at which cell-specific reference signals for the beam search will be transmitted by the gNB;
evaluate the cell-specific reference signals included in beam search transmissions to select a beam to use for a 5G NR communication link between the gNB and the UE; and
transmit an indication of the selected beam to the gNB, the transmission being effective to cause the gNB to establish the 5G NR communication link with the UE using the selected beam.

18. The system of claim 17, further comprising:
a serving cell gNB including an Xn interface, the serving cell gNB configured to:
receive the transmitted beam search request from the UE;
forward the beam search request to the gNB via the Xn interface;
receive, via the Xn interface, the beam search notification from the gNB; and
transmit the beam search notification to the UE.

19. The system of claim 17, wherein the beam search request, and the indication of the beam to use for the 5G NR communication link are communicated to the gNB via a supplemental uplink of the gNB.

20. The system of claim 17, wherein the parameters for the beam search include one or more of: a number of beams to transmit by the gNB during the beam search, a duration of transmission for each beam during the beam search, and a channel or frequency band for the transmission of the beams by the gNB.
